(19) United States
(12) Patent Application Publication
(10) Pub. No.: US 2010/0021652 A1
(43) Pub. Date: Jan. 28, 2010

(54) METHOD OF FORMING ELECTRICAL TRACES

(75) Inventors: CHENG-HSIEN LIN, Tayuan (TW); YAO-WEN BAI, Shenzhen (CN); RUI ZHANG, Shenzhen (CN)

Correspondence Address: PCE INDUSTRY, INC.;ATT. Steven Reiss, 288 SOUTH MAYO AVENUE, CITY OF INDUSTRY, CA, 91789, US

(73) Assignees: FUKUI PRECISION COMPONENT (SHENZHEN) CO., LTD., Shenzhen City (CN); FOXCONN ADVANCED TECHNOLOGY INC., Tayuan (TW)

(21) Appl. No.: 12/494,279

(22) Filed: Jun. 30, 2009

(30) Foreign Application Priority Data
Jul. 28, 2008 (CN) 200810303134.5

(51) Int. Cl. B05D 3/06

(52) U.S. Cl. 427/552; 427/553

(57) ABSTRACT

A method of forming electrical traces includes the steps of: providing a substrate; printing an ink pattern using a silver containing ink on the substrate, the ink comprising an aqueous carrier medium having dissolved therein a water-soluble light sensitive silver salt; irradiating the ink pattern to reduce silver salt therein to silver particles thereby forming an underlayer; and electroless plating a metal overcoat layer on the underlayer thereby obtaining electrical traces.

### CROSS-REFERENCE TO RELATED APPLICATIONS

This application is related to commonly-assigned copending applications under application No. 12/235,994, entitled “METHOD OF FORMING CIRCUITS ON CIRCUIT BOARD”, application Ser. No. 12/253,869, entitled “PRINTED CIRCUIT BOARD AND METHOD FOR MANUFACTURING SAME”, and application Ser. No. 12/327,621, entitled “INK AND METHOD OF FORMING ELECTRICAL TRACES USING THE SAME”. Disclosures of the above-identified applications are incorporated herein by reference.

### BACKGROUND

1. Technical Field

The present disclosure relates generally to manufacturing of printed circuit boards (PCBs), and particularly, to a method of forming electrical traces of a printed circuit board using printing method.

2. Description of Related Art

Ink jet circuit printing is becoming more and more popular and attractive in the fabrication of printed circuit boards due to its high flexibility. In a typical ink jet circuit printing method, an ink containing a great number of micro metal particles is printed onto a specified area of a substrate using an ink jet printer to create a pattern of ink. A metal pattern comprised of metal particles is obtained after solvents in the pattern of ink are removed. However, the metal particles in the metal pattern have loose contact between each other, and accordingly, the metal pattern has poor electrical conductivity. A heating process (for example, sintering at 200 to 300 degrees Celsius (° C.)) is required to bond the metal particles together, thereby improving the electrical conductivity of the metal pattern. However, commonly used substrates for printed circuit boards are comprised of polymer such as polyimide, which has low heat resistance. Thus, even at 200 to 300° C., the substrate starts to soften and deform, and the quality of the substrate and the electrical traces may be compromised.

Therefore, there is a desire to overcome the aforementioned problems.

### BRIEF DESCRIPTION OF THE DRAWINGS

Many aspects of the present method of forming electrical traces on a substrate can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a flowchart of a method of forming electrical traces on a substrate in accordance with an exemplary embodiment.

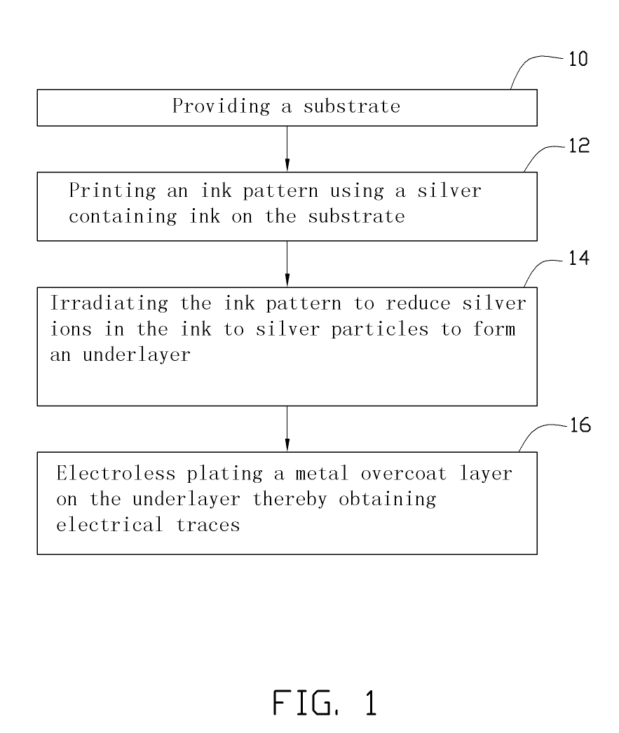

FIG. 2 is a cross-sectional view of part of an exemplary substrate used in the method of FIG. 1.

FIG. 3 is similar to FIG. 2, but showing an ink pattern printed on a surface of the substrate.

FIG. 4 is similar to FIG. 3, but showing the ink pattern transformed into an underlayer.

FIG. 5 is similar to FIG. 4, but showing the structure after a metal overcoat layer has been plated on the underlayer thereby obtaining electrical traces.

### DETAILED DESCRIPTION

A method of forming electrical traces on a substrate using a silver containing ink will be described in detail with reference to accompanying figures.

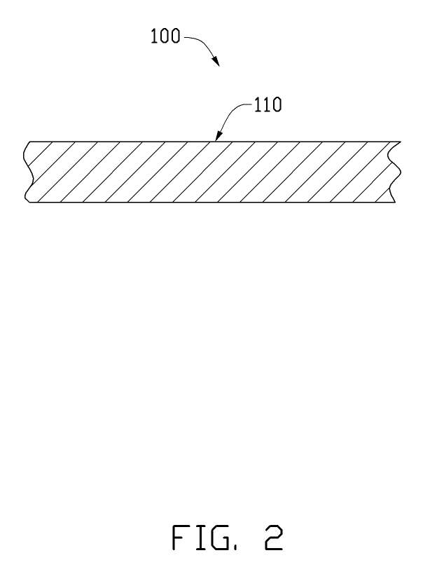

In step 10, referring to FIG. 2, a substrate 100 is provided. The substrate 100 is material suitable for carrying printed circuits, such as polyimide (PI), polyethylene terephthalate (PET), polyarylene ether nitrile (PEN), and others. The substrate 100 has a surface 110. The surface 110 can be cleaned prior to performing the remainder of the method. For example, the substrate 100 can be ultrasonically processed in a mixture of acetone, tert-butyl alcohol, and deionized water for 5 to 15 minutes, and then dried.

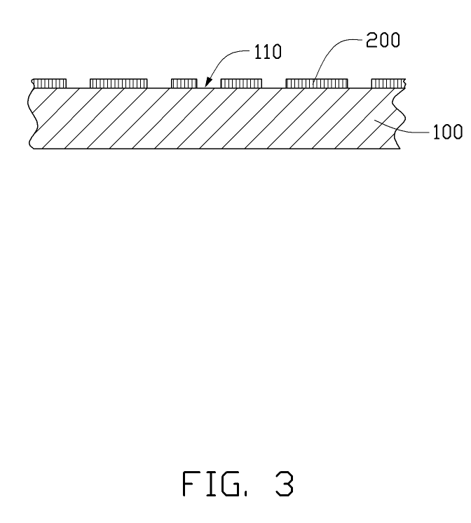

In step 12, referring to FIG. 3, an ink pattern 200 comprised of the silver containing ink is printed on the substrate 100. The ink pattern 200 is formed on the surface 110 using ink jet printing, wherein an ink jet printer forms the ink pattern 200 using the silver containing ink. In the present embodiment, an Epson™ R 230 ink jet printer equipped with special disc tray is employed to print the ink pattern. Limited by the Epson™ R 230 ink jet printer, the minimum line width of the ink pattern 200 is 0.1 mm. However, it is understood that the minimum line width can be further decreased by employing high resolution printers. As silver salts are uniformly dissolved in the silver-containing ink, the silver salts are also uniformly distributed in the ink pattern 200.

The silver containing ink includes water, a water-soluble light sensitive silver salt, an ink binder, and a water-soluble organic solvent. The water-soluble light sensitive silver salt is selected from the group consisting of silver nitrate, silver sulfate, silver acetate, and silver citrate, and concentration of the water-soluble light sensitive silver salt in the silver containing ink is in a range from approximately 0.02 mol/L to approximately 2 mol/L. Examples of the ink binder include polyvinylalcohol (PVA) and polyvinylpyrrolidone (PVP), and any other suitable water-soluble resin. The concentration of the ink binder is in the range from approximately 0.1% to 2% by weight. The water-solution organic solvent can be water-soluble alcohols such as methyl alcohol, ethyl alcohol, 1,2-propylene glycol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol, water-soluble ether such as methyl ether, ethyl ether, and ethylene glycol monobutyl ether. The concentration of the water-soluble organic solvent is in a range from approximately 5% to approximately 50% by weight. The concentration of water in the silver containing ink is in a range from approximately 20% to approximately 95% by weight.

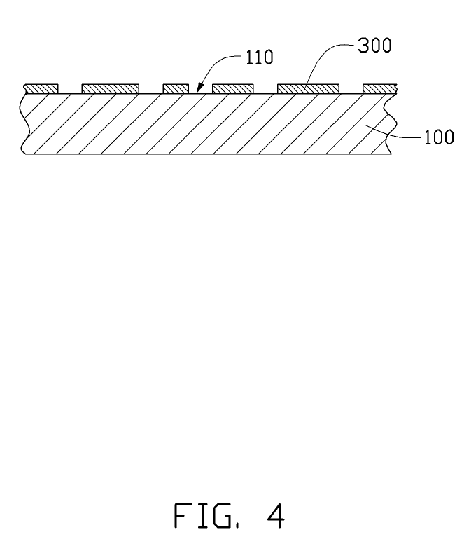

Continuing to step 14, referring to FIGS. 3 and 4, the ink pattern 200 is irradiated to reduce the silver salts therein to silver particles, thereby forming an underlayer 300. The irradiation can be by any suitable form of high energy radiation, such as ultraviolet laser light or y radiation. The irradiation generally lasts from approximately 5 to approximately 30 minutes. In the present embodiment, the substrate 100 with the ink pattern 200 formed thereon is placed in an ultraviolet transilluminator to perform this step. The type of irradiation and the period of irradiation can be varied according to the light sensitive reducing agent employed.

Optionally, the substrate 100 with the ink pattern 200 formed thereon can be dried at approximately 65° C. prior to or after the irradiation step. The drying effectively evaporates other liquid solvents of the ink (e.g., the aqueous carrier medium), with only the solid silver particles remaining to form the underlayer 300. Average particle size as measured by a scanning electron microscope (SEM) is approximately 60 to 300 nm (nanometers). The nanoscale silver particles are distributed on the surface 110 regularly and evenly, whereby the underlayer 300 correspondingly has a uniform width and thickness. In other embodiments, the average particle size of the silver particles can be of any suitable scale, such as nanoscale (e.g., 1 nm to 999 nm) or microscale (e.g., 1 micrometer to 100 micrometers).

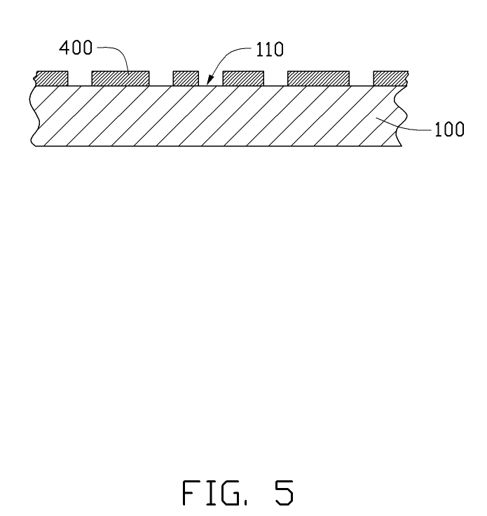

In step 16, a metal overcoat layer is plated on the underlayer 300 using electroless plating, thereby forming a number of electrical traces 400, as shown in FIG. 5. Generally, the underlayer 300 comprised of a number of silver particles has low electrical conductivity due to its incompact structure. Thus, the metal overcoat layer plated on the underlayer 300 yields the electrical traces 400 which have improved electrical conductivity. In the plating process, each of the silver particles in the underlayer 300 is a reaction center, and the metal encapsulates each of the silver particles. Spaces (interstices) between adjacent silver particles are entirely filled with the metal. Thereby, the silver particles of the underlayer 300 are electrically connected by the metal, thus providing the electrical traces 400 with good electrical conductivity.

The metal overcoat layer can be comprised of copper or nickel. In the present embodiment, the metal overcoat layer is a copper layer, and an electroless plating solution used to form the copper layer includes copper sulfate, formaldehyde, potassium sodium tartrate, and ethylenediaminetetraacetic acid (EDTA). The underlayer 300 is dipped into the electroless plating solution comprising a plurality of copper ions at approximately 50° C. for approximately 1.5 minutes. Average particle size of the copper particles is from about 50 nm to about 150 nm. Typically, the copper particles also form a continuous overlayer of copper on the silver particles, such that the electrical traces 400 have smooth copper top surfaces.

In order to test performance of the silver containing ink of different compositions, inks having composition as listed in table 1 are prepared, and then used to form electrical traces on a polyimide substrate using the method as discussed above. The test results of electrical traces made from these inks are recorded in table 2.

TABLE 1
composition of silver containing inks

| | | | Ethylene | | | |
|---|---|---|---|---|---|---|
| | | | glycol | | | |
| | | | monobutyl | Silver | | Irradiation |
| | Water | 1,2-propylene | ether | nitrate | | time |
| Examples | (wt. %) | glycol (wt. %) | (wt. %) | (mol/L) | PVP (wt. %) | (min) |
| Example 1 | 73 | 25 | 2 | 0.01 | 0 | 15 |
| Example 2 | 70 | 25 | 5 | 0.01 | 0 | 15 |
| Example 3 | 69.5 | 20 | 10 | 0.02 | 0.5 | 15 |
| Example 4 | 69.5 | 15 | 15 | 0.02 | 0.5 | 15 |
| Example 5 | 69.67 | 16.7 | 13.3 | 0.17 | 0.33 | 15 |
| Example 6 | 69.5 | 15 | 15 | 0.17 | 0.5 | 15 |
| Example 7 | 69.5 | 16.7 | 13.3 | 0.17 | 0.5 | 15 |
| Example 8 | 69.33 | 16.7 | 13.3 | 0.17 | 0.67 | 15 |
| Example 9 | 69.17 | 16.7 | 13.3 | 0.17 | 0.83 | 15 |
| Example 10 | 68 | 16.7 | 13.3 | 0.17 | 2 | 15 |

TABLE 2
Test results of electrical traces made from inks listed in table 1

| | | | Line width of |
|---|---|---|---|
| | Eletroless plating | Continuity of ink | electrical |
| Examples | ability | pattern | traces(mm) |
| Example 1 | The electroless | discontinuous | 0.13 |
| Example 2 | plating solution is | discontinuous | 0.14 |
| | destroyed | | |
| Example 3 | OK | discontinuous | 0.1 |
| Example 4 | OK | discontinuous | 0.11 |
| Example 5 | OK | continuous | 0.11 |
| Example 6 | OK | continuous | 0.11 |
| Example 7 | OK | continuous | 0.12 |
| Example 8 | OK | continuous | 0.1 |
| Example 9 | OK | continuous | 0.1 |
| Example 10 | OK | discontinuous | 0.09 |

As shown in Table 2, concentration of organic solvents (e.g., ethylene glycol monobutyl ether), PVK, and silver nitrite are key factors effecting quality of finally obtained electrical traces. If the concentration of the organic solvents is less than 13.3% by weight, the wettability of the silver containing ink on a surface of polyimide is too low and the silver containing ink shrinks a lot thereby causing the ink to separate into droplets. As a result, the electrical traces are discontinuous. With increasing concentration of the ink binder (e.g., PVP), silver particles more easily to adhere to the surface of polyimide substrate. However, if the concentration of the ink binder is greater than approximately 2% by weight, the ink binder will enclose the silver particles, and the silver particles can't serve as a catalyst of the electroless plating reaction in this condition. Thus, the continuity of obtained electrical traces also fails to meet the requirements. An appropriate concentration of the ink binder is in a range from approximately 0.5% to approximately 0.87% by weight.

TABLE 3
Test results of electrical traces made from inks having the
composition of Example 5 and irradiated for different periods

| | | | | Line |
|---|---|---|---|---|
| | Irradiation | | | width of |
| | time | Eletroless | Continuity of | ink pattern |
| Examples | (min) | plating ability | ink pattern | (mm) |
| Example 11 | 5 | The electroless | discontiguous | 0.15 |
| | | plating solution | | |
| | | is destroyed | | |
| Example 12 | 10 | OK | continuous | 0.11 |
| Example 13 | 15 | OK | continuous | 0.1 |
| Example 14 | 20 | OK | continuous | 0.12 |
| Example 15 | 30 | OK | continuous | 0.11 |

As shown in Table 3, the irradiation time should be longer than 5 minutes. The longer the irradiation time is, the more silver salts are reduced to silver particles. In the continuing process, the silver particles serve as catalyst of the electroless plating reaction. In this consideration, it is better to irradiate the ink pattern for a long period. However, performance of polyimide also deteriorates under the irradiation. Therefore, the irradiation time should be limited to a certain range (e.g., 5 minutes to 30 minutes), which is capable of producing adequate silver particles.

In other embodiments, prior to the ink pattern being formed, the polyimide substrate is submerged in a solution of potassium hydroxide in water at a concentration of 3 mol/L for approximately 30 seconds, and then electrical traces are printed using silver containing ink having the composition as Example 8. Test results show that obtained electrical traces have good continuity, but the line width of electrical traces increases to 0.15 mm (the printed ink pattern is still printed at a line width of 0.1 mm). This is because the potassium hydroxide treatment improves a wettability of the silver containing ink on the surface of the polyimide substrate. In addition, the obtained electrical traces have a better adhesion to the polyimide substrate.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A method of forming electrical traces, the method comprising:
providing a substrate;
printing an ink pattern using a silver containing ink on the substrate, the ink comprising an aqueous carrier medium having dissolved therein a water-soluble light sensitive silver salt;
irradiating the ink pattern to reduce silver salt therein to silver particles thereby forming an underlayer; and
electroless plating a metal overcoat layer on the underlayer thereby obtaining electrical traces.

2. The method as claimed in claim 1, wherein the metal overcoat layer is a copper overcoat layer.

3. The method as claimed in claim 1, wherein an electroless plating solution used in the electtroless-plating process contains copper sulfate, potassium sodium tartrate, ethylene diamine tetraacetic acid disodium salt, formaldehyde and methanol.

4. The method as claimed in claim 1, wherein the irradiation ray is an ultraviolet ray, or a γ-ray.

5. The method as claimed in claim 1, wherein the ink pattern is irradiated for about 5 minute to about 30 minutes.

6. The method as claimed in claim 1, wherein the water-soluble light sensitive silver salt is selected from the group consisting of silver nitrate, silver sulfate, silver acetate, and silver citrate.

7. The method as claimed in claim 1, wherein the ink further comprises a surfactant dissolved therein.

8. The method as claimed in claim 1, wherein an electroless plating solution used in the electroless plating step comprises a copper compound, a reducing agent, and a complex agent.

9. The method as claimed in claim 1, wherein the reducing agent is potassium sodium tartrate.

10. The method of claim 1, wherein the substrate is treated with a solution of potassium hydroxide in water prior to printing the ink pattern.

11. The method of claim 1, wherein the substrate is ultrasonically processed in a mixture of acetone, tert-butyl alcohol, and deionized water for 5 to 15 minutes prior to printing the ink pattern.
